(19) United States
(12) Patent Application Publication
(10) Pub. No.: US 2020/0341543 A1
(43) Pub. Date: Oct. 29, 2020

(54) WEARABLE DEVICE

(71) Applicant: SCRRD, Inc., Seattle, WA (US)

(72) Inventors: Lucas Kane Thoresen, Seattle, WA (US); Joshua Ian Cohen, Seattle, WA (US)

(21) Appl. No.: 16/897,893

(22) Filed: Jun. 10, 2020

Related U.S. Application Data
(63) Continuation-in-part of application No. PCT/US2019/028818, filed on Apr. 23, 2019.
(60) Provisional application No. 62/859,888, filed on Jun. 11, 2019.
(60) Provisional application No. 62/661,573, filed on Apr. 23, 2018.

(51) Int. Cl. G06F 3/01; G06F 3/16

(52) U.S. Cl. CPC G06F 3/011; G16Y 10/75; G06F 3/167

(57) ABSTRACT

A wearable device is disclosed. In one embodiment, the wearable device includes a hardware layer, a touch having a capacitive touch surface that receives contact data, and a radio layer including a plurality of antennas that receive radio data. The wearable device processes the radio data and the contact data to at least one of increase internet-of-things awareness and execute a gesture command originating from the user. The wearable device also processes the laryngeal data to execute a vocalization command originating from the user.

### PRIORITY STATEMENT & CROSS-REFERENCE TO RELATED APPLICATIONS

This application claims priority from co-pending U.S. Patent Application Ser. No. 62/859,888 entitled “Wearable Device” and filed on Jun. 11, 2019, in the names of Joshua Ian Cohen et al.; which is hereby incorporated by reference, in entirety, for all purposes. This application is also a regular national application filed under 35 U.S.C. § 1.111(a) claiming priority under 35 U.S.C. § 120 to the Apr. 23, 2019 filing date of co-pending International Application Serial No. PCT/US2019/28818, which designates the United States, filed in the names of Joshua Ian Cohen et al. and entitled “Wearable Device;” which claims priority from U.S. Patent Application No. 62/661,573, entitled “Pendant Laryngeal Human Input System” and filed on Apr. 23, 2018, in the names of Lucas Thoresen et al.; which are both hereby incorporated by reference, in entirety, for all purposes.

### TECHNICAL FIELD OF THE INVENTION

This invention relates, in general, to wearable devices and, in particular, to enhanced performance in wearable devices that provide context with an environment of a user.

### BACKGROUND OF THE INVENTION

Wearable technology has a variety of applications which grows as the field itself expands. It appears prominently in consumer electronics with the popularization of the smartwatch and activity tracker. Apart from commercial uses, wearable technology is being incorporated into navigation systems, advanced textiles, healthcare, and an ever increasing number of applications. As a result of growing needs and an expanding consumer preference, there is a need for improved wearable technology.

### SUMMARY OF THE INVENTION

It would be advantageous to achieve new wearable technology that would improve upon existing limitations in functionality and increase ecosystem offerings. It would be desirable to enable an electro-mechanical based solution leveraging hardware that would provide enhanced services. To better address one or more of these concerns, a wearable device is disclosed. In one embodiment, the wearable device includes a hardware layer with a capacitive touch recognition surface on one side. The wearable device receives contact data as well as serving as a form of gestural input, which allows for many additional gestures. The wearable device also has a radio layer that surveys wireless signal data with multiple antennas that receive radio data, for example. The wearable device may process incident wireless signals and uses gestural training data to recognize the intended action before attempting to execute the gesture as a command or user input. The wearable device also processes the laryngeal data to execute subvocal commands that are recognized by a separate training set. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic diagram of a user wearing one embodiment of a wearable device according to the teachings presented herein;

FIG. 2 is a schematic diagram of the user depicted in FIG. 1 wearing the wearable device in additional detail;

FIG. 3A, FIG. 3B, FIG. 3C, and FIG. 3D are each schematic diagrams of one embodiment of a portion of the wearable device;

FIG. 4A, FIG. 4B, FIG. 4C, and FIG. 4D are each schematic diagrams of one embodiment of a portion of a larynx member;

FIG. 5 is a conceptual module diagram depicting a software architecture of an environmental control application;

FIG. 6A, FIG. 6B, FIG. 6C, and FIG. 6D are each schematic diagrams of one embodiment of a portion of a thermoelectric charging configuration for the wearable device; and

FIG. 7A and FIG. 7B are each schematic diagrams of one embodiment of a portion of a thermoelectric charging pads for the wearable device.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

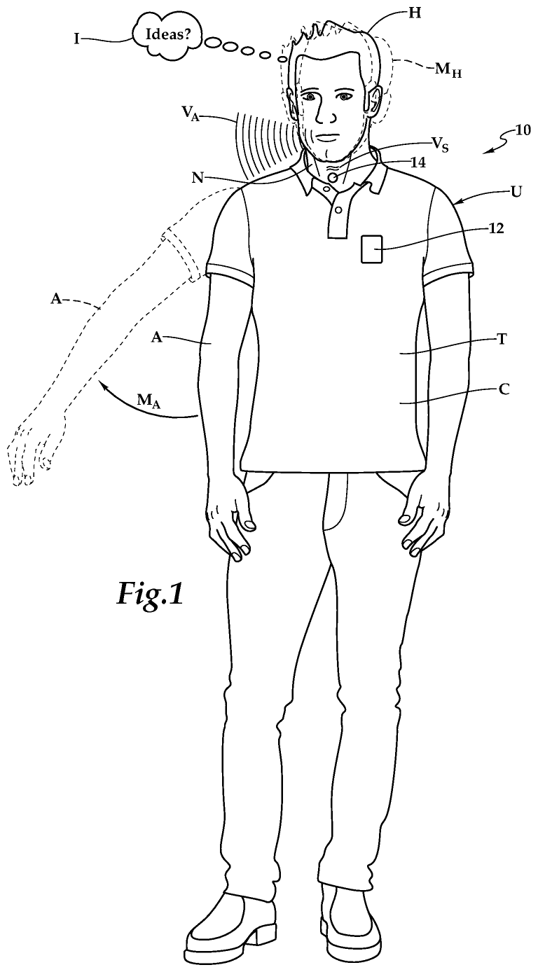

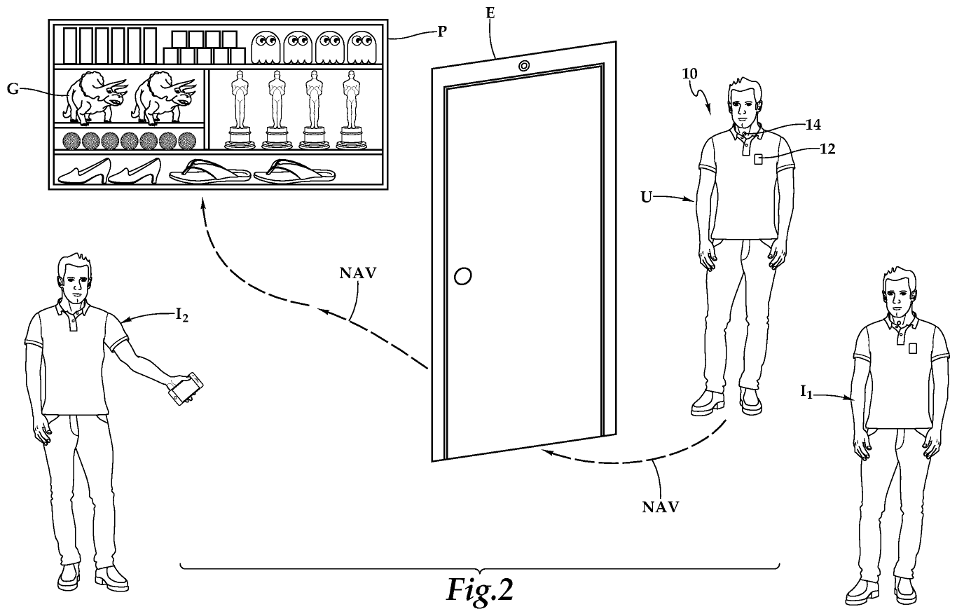

Referring initially to FIG. 1 and FIG. 2, therein is depicted one embodiment of a system including wearable technology that is conceptually illustrated and generally designated 10. A user U has a torso T and an arm A as well as a neck N and a head H. The user U is wearing clothing C. Further, the user U is wearing a wearable device 12 on the clothes C and a larynx member 14 is affixed to the neck N. In general, the wearable device 12 is responsible for processing radio and contact data, determining bearings for incident wireless signals, and processing signals collected by the contacts of the larynx member. The various data received may be utilized and to improve the overall visibility of internet-of-things (IOT) devices around the user to give the user awareness of neighboring devices that may be accepting pairing, sharing, and caring requests in the area. The system might execute a gesture command on behalf of the originating system's logged-in user U. The wearable device 12 also processes the laryngeal data to execute a vocalization command originating from the user U.

With respect to FIG. 1, the wearable device 12 processes the radio data and the contact data to detect the arm A movement as shown by arrow M_{A}. The wearable device 12 processes the laryngeal data received from the larynx member 14 to detect audible vocals V_{A} and even sub-audible vocals V_{S}. Based on the detected audibles, the wearable device 12 may execute a command or initiate a telephony application, including transmission of an audible vocalization or transmission of a sub-audible vocalization. Also, audible commands or sub-audible commands may be enabled. The wearable device 12 may also process the laryngeal data that includes movement of the head H as shown by M_{H}, including the detection of biometrics that may indicate what the user is thinking or feeling as shown by element I.

With respect to FIG. 2, the wearable device 12 processes the radio data and the contact data to provide multiple credential authentication, such as, for example, authentication that permits the user U to go through the entrance E. Additionally, as shown in FIG. 2, the user U by way of the processing of the radio data and the contact data has device-to-device awareness of the individual I₁ having a wearable device and the individual I₂ having a smart device. Using interactive navigation as shown by NAV and enabled by the processing of the radio data and the contact data, the user U is able to visit the purchasing area P and select a gift G for purchase. A purchase that may be enabled by the wearable device 12.

The wearable device 12 can be used for everyday computing, authentication, telephony, navigation, and as an entry point into augmented reality space. It is designed to excel in performance, device awareness, security, design, user interactions, and accessibility. The wearable device makes use of multiple antennae and wireless tracking technology in order to provide enhanced location awareness. It also means that the wearable device understands cardinal directions or bearings of nearby devices for use in software applications and support for location-aware gestures.

The wearable device 12 works hand in hand with the larynx member 14 and, as will be discussed in further detail hereinbelow, includes a radar-enhanced capacitive touch surface which provides maximum accessibility for all users. The on-board radar chip understands precise hand movements and can detect objects that are directly in front of the device. When augmented with the capacitive touch surface and hands-free laryngeal interface, the combination allows users to interact with the world around them in new ways. The user should be able to signal towards neighboring devices and interact with them directly, or the user may decide to speak phrases assigned to public and restricted commands under the user's breath.

The wearable device 12 also lets a user bring desktop functionality with the user as the user roams utilizing a roaming profile of the desktop environment. Such a roaming profile is loadable on neighboring devices that do have screens, or directly accessible via a VNC connection that can be formed on-the-fly. This allows the user to access files from a supported machine running the software or for any machines supporting the automatic VNC session formation protocol. It should be appreciated that even though a wearable device 12 is depicted on the clothing C, the wearable device 12 may be on a necklace, for example, or otherwise associated with the user U. Even though the necklace wearable device 12 doesn't have a built-in screen, the device leverages a proximity-based wireless VNC protocol in order to display the graphical desktop on neighboring device displays. Once a display-bearing device (Laptop, Desktop, TV, or Smartphone) has been paired, bringing the wearable within range and performing the hold gesture will cause the two devices to form a VNC connection. This means that users can bring their desktop with them wherever they go.

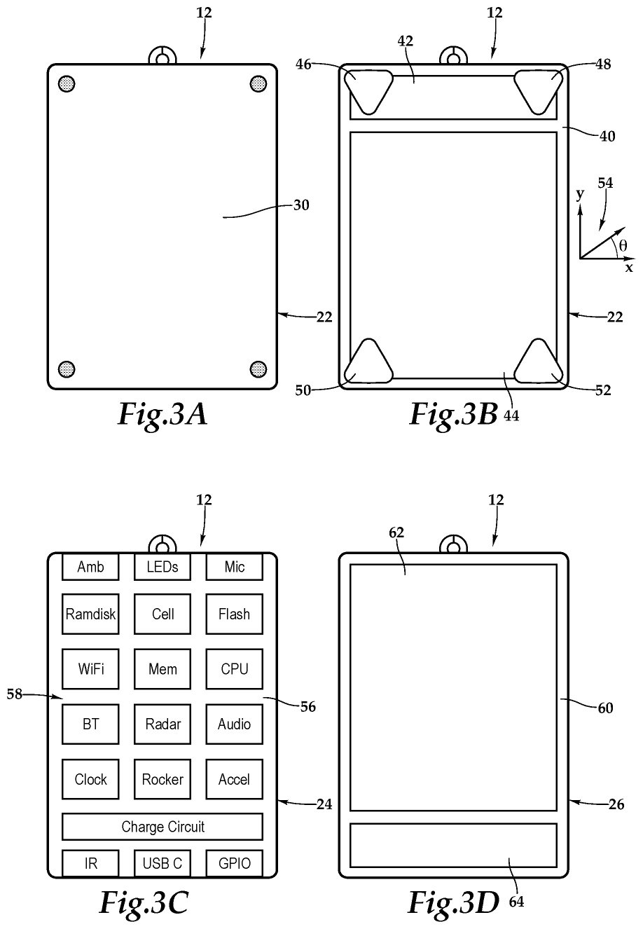

Referring now to FIG. 3A, FIG. 3B, FIG. 3C, and FIG. 3D, the wearable device 12 includes an outer touch layer 20, an interior radio layer 22, an interior hardware layer 24, and an exterior electrical layer 26. The outer touch layer 20, the interior radio layer 22, the interior hardware layer 24, and the exterior electrical layer 26 are interconnected.

The outer touch layer 20 includes a capacitive touch surface 30. The interior radio layer 22 includes a substrate 40 securing a cell antenna 42, which may be a transceiver, and an induction coil 44 as well as, in one embodiment spaced and segmented, antennas 46, 48, 50, 52. The capacitive touch surface 30 in conjunction with the antennas 46, 48, 50, 52 can determine the direction of signals as indicated by element 54. The interior hardware layer 24 includes a substrate 56 having components 58 including Amb, LEDs, Mic, Ramdisk, Cell, Flash, WiFi, Mem, CPU, BT, Radar, Audio, Clock, Rocker, Accel, Charge Circuit, IR, USB C, and GPIO, for example. It should be appreciated that although a particular architecture of components is depicted, other architectures are within the teachings presented herein. Within the CPU, the memory is accessible to the processor and the memory includes processor-executable instructions that, when executed, cause the processor to process radio data and contact data relative to at least one signals source radio. This helps to improve IOT awareness, improve the overall gesture system, and execute commands on device neighbors in the vicinity. Furthermore, instructions may cause the processor to process the laryngeal data in a learned fashion. Signal samples may be read from each contact source and used in a training program designed to improve subvocal recognition accuracy. Finally, the exterior electrical layer includes a substrate 60 having a shielded battery 62 and a heatsink 64.

The wearable device 12 may come with one or more segmented antennas, that can identify the points of origin of incoming radio signals, by using low observable tracking techniques, and angle-of-arrival techniques seen in phased-array radar systems. Segments may be spaced equally apart from each other at increments relative to the frequency of the wave. For example, the antennas may be placed at squared distances apart from each other, at one waves distance, or at one-half, one-quarter, one-eighth and one-sixteenth wavelengths apart. The wearable device 12 may also make use of the phased-array antenna to steer wireless signals back towards a destination access-point or device. Especially during authentication and directed file transfers, signal isolation and quality benefits will occur. The system may programmatically choose to steer signals back towards another device in the same direction that the signals were received in, adjusted to changes in the device's position, while improving connectivity and wireless privacy.

It should be mentioned that phased-arrays are not usually present in consumer products, and that portable device can use the low observable techniques to improve mobile applications. However, directional awareness of neighboring devices, allows for far more complex gestures, and opens a world of possibilities for navigation and augmented reality technology, allowing the device to visualize the wireless space, and all of those ‘WiFi radar’ apps to actually work.

Users might also want a chaintenna, that is, an antenna dipole that has been strung into the chain that is relatively low-power and clips onto the sides of the wearable device. The antenna can be used for cellular, WiFi, or Bluetooth radios, and keeps the device facing forward. It is high-gain, as the dipole extends through the chain, and is usually longer than the body of the wearable device. Depending on the material and conductivity status of the chain and type of radio transmission, the dipole might also be insulated separately and capped at either end. The chaintenna might have some degree of resistivity between the conductive leads that scales appropriately to the frequency that the antenna is meant to operate on, and is calculable with techniques known in the art of antennas.

The wearable device 12 may also have a capacitive radar-enhanced multi-touch surface. This involves a capacitive pad grid that measures the locations of multiple fingers or conductive objects on an X, Y plane from each of the corners of the pad. It is combined with a radar sensor underneath the pad that emits radio pulses outwards that bounce off of the user's hands and land back on the pad. The combination allows the pad to measure the distance to the user's hand, yielding a Y-coordinate on the two-dimensional touch plane, giving the pad three-dimensional awareness in a manner that is mechanically similar to the doppler-shift ultrasound techniques.

Furthermore, the radar sensing provides a positional offset from the center point where the signals were emitted, and likewise, another analog waveform that can be fed into machine-learning software. This lets users train the pad to recognize specific movements of the hands in front of the device and perform free-space gestures which are invokable by the user through normal operation of the wearable member 12. Since there does not need to be a direct visualization of what is on the display, the touchpad gives users the ability to convey what should be selected, playing, or otherwise happening. The device is said to be contextual in nature, as the device has a certain degree of environmental awareness. Depending on what happens around the time a gesture is made, the device will perform an appropriate action.

The embedded form-factor of the wearable device is available to developers for the purpose of providing a modular development platform that can be used inside existing products or as a badge, for example, that is releasable securable to the clothing C of the user U. The embedded version may expose development endpoints such as the GPIO serial connector, wired and/or wireless network interface modules, USB, and a software API (application programming interface). Developers and hobbyists can experiment with the platform and connect different modules appropriate to each project they work on. Businesses can embed the platform and deploy wearable device-compatible consumer products with their own functionality, purpose, and branding. The platform can be locked-down for mass deployment, by removing unneeded development modules, leaving only the required components for deployment in the product at scale. Embedding the wearable device ensures that the software protocol implementation is consistent among many different kinds of devices, including doors and toasters, which makes for a secure and open firmware platform that IOT users can benefit from.

The wearable device 12 may be utilized in different contexts. In a pocketed context, users might put their wearable device 12 in a closed space, or in their pocket. Similar to on-face detection seen in smartphones, the wearable device 12 uses a light sensor to determine whether there is something directly in-front or behind-it. If both sensors return a closed value of less than a few centimeters, then the device might enter pocketed context. In pocketed context, the wearable device 12 will not respond to any gestures that the user U would not reasonably perform in their pocket. This is both a safety mechanism to protect the device from accidental input and works to the benefit of the user U who might use pocketed interactions inside, such as triple tapping on the device to silence a notification.

If the wearable device 12 is an embedded device, the software might stay in embedded context, which is because the wearable device software has detected that it's running on a device that is embedded inside another product. That product may or may not have a touch surface or offer direct physical user interaction whatsoever. However, in this mode, network connectivity, and the ability to interact with the system remotely is supported and streamlined with the API and software development kit.

In another context, the wearable device 12 may be utilized to carry data analogously to bringing your desktop workspace with you on-the-go. Even though the necklace wearable device 12 doesn't have a built-in screen, the device leverages a proximity-based wireless VNC protocol that it uses to display a graphical desktop on neighboring devices that are running the software. Once a display-bearing device (Laptop, Desktop, TV, or Smartphone) comes within range, the wearable device 12 pairs to it and either shares a roaming workspace or display a graphical shell on neighboring devices via a VNC protocol. Simply bringing the wearable within range and performing the hold gesture will cause the two devices to form a VNC connection. This means that users can bring their desktop with them wherever they go.

To effectuate many of these functions, named items are available to the user as a sort of vocal shortcut for physical and virtual objects. When a user names an object, the aspects of the object that make it unique are stored in a searchable mapping of unique identifiers or hashes, as they relate to specific data structures and types, such as file or device. Users might choose to create places where they can store files, and spaces where they can reference objects.

There might be a place where the user U keeps their music, and when they are searching for a song, if they can name the place, the user U can narrow results faster. If the user U wanted to copy a device, they might say something like, “to my phone”, and as expected, the lookup would result in the user's phone, but might have a completely different machine identifier. This is something that is common to voice assistants but is especially important for devices without a screen.

In another sense, if the user U can describe what something looks like as they name it, or the properties about it, it can make the process of finding it again much easier, and more organic than trying to remember the exact name of the object or trying to walk through the filesystem directory by directory.

If a named object happens to be a device, then the wearable device 12 should save the device's cryptographic signature, and wireless profile. It may be the case that the device does not support pairing at all, but speaks a common language such as WiFi or Bluetooth. Identifying the commonalities of wireless frames (building a profile) and saving the MAC address (a typically unique but non-unique identifier) can be used to find overlapping traits between devices. Say for example, the user U holds an ordinary cell phone in front of the wearable device 12, and names it “Mobile Phone”. Later on, when the wearable device 12 does wireless discovery and identifies a device that has a different MAC address, but is emitting frames with a similar wireless profile, the wearable device 12 might ask the user U, “Is what you're holding a Mobile Phone?”.

This makes it easier to name categories of IOT devices, so when the user goes to their friend's house and encounters a similar device, the wearable device 12 already knows how to interact with it, as it matches something else used before.

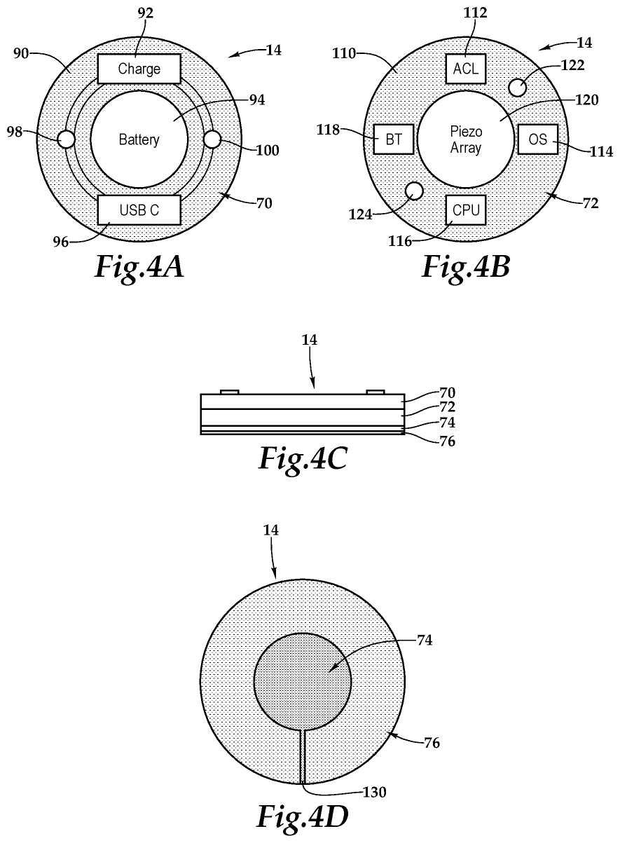

Referring now to FIG. 4A, FIG. 4B, FIG. 4C, and FIG. 4D, in one embodiment, the larynx member 14 includes multiple layers, a layer 70, a layer 72, a layer 74, and a layer 76. With respect to the layer 70, a substrate 90 supports a charging interface 92, a battery 94, and a USB C interface 96. A power button 98 is provided as is a power LED button 100. With respect to the layer 72, a substrate 110 supports an ACL 112, OS 114, a CPU 116, and a BT 118, as well as a piezo array 120. A microphone 122 and a resistivity sensor 124 are also provided. With respect to the layer 74 and the layer 76, a piezoelectric sensing array is provided with an ultrasound gel being applied to layer 74. A gel escape channel 130 provides communication to the exterior from the layer 74. A medical grade adhesive may be applied to the exterior. It should be appreciated that although a particular architecture of components is depicted, other architectures are within the teachings presented herein. Within the CPU 116, the memory is accessible to the processor and the memory includes processor-executable instructions that, when executed, cause the processor to process the piezoelectric data and sound data. Further, the processor-executable instructions cause the processor to apply machine learning to train and recognize meanings associated with the piezoelectric data and sound data.

The larynx member 14 provides an interface device that is also a portable computer, complete with a processor, memory, and a wireless chipset, that rests on the outside of the neck. The wireless sticker version of the larynx member 14 has a replaceable adhesive material and is small enough where it does not become a distraction. Users slide an inexpensive replaceable medical-grade adhesive sticker onto the bottom of the device and apply a small amount of an ultrasound gel directly on top of a piezoelectric sensing array. Any excess ultrasound gel will escape through an inset escape channel, which ensures that there are no air pockets between the piezoelectric array and the surface of the skin.

The medical grade adhesive holds the device securely on the outside of the neck and can be positioned so that it is facing the larynx, near to the laryngeal nerve, underneath the jaw, on the spot on the outside of the neck that moves with the larynx, mouth and tongue. As the user vocalizes, subvocalizes, or whispers to themselves (silent self-talk), the analog waveforms representing the movements of the larynx muscles and throat are captured by the ultrasound piezoelectric array and accelerometer. Any audible sound will be captured by one or more throat microphones that provide another analog data point for combined processing.

Since the device may be in a sticker form, there are resistivity leads for detecting perspiration on the outside of the skin that may weaken the medical adhesive bond. This makes the user of the device aware of when the adhesive sticker or patch needs to be replaced. For medical use, this can signify that the user is becoming anxious or reacting negatively to a stressor. This information is useful for early detection of psycho-emotional states like anxiety or excitement. Doctors might find this information useful in gauging the severity of an anxiety disorder or for measuring the frequency of panic attacks as seen in panic disorder.

The larynx recognition technology is derived from several prior works in government and the medical industry, where the movements of the larynx that help to form human speech were captured as analog waveforms and conveyed to an external device using radio frequency (RFID) technology.

The larynx sticker also measures muscular movement, except that it accounts for the movement of the muscles in the throat that move with the tongue, in terms of machine learning, and works on the outside of the neck to reconstruct silent speech. As the user's tongue and larynx muscles move, the side of the neck moves, and the device is able to recognize silent speech patterns or ‘subvocalizations’ that the person will produce during speech, with a hybrid sensor machine-learning approach. This makes the larynx interface, a non-invasive technology, that can aid users with speech and may work for medical patients who have lost their ability to speak. It is also useful for normal users who wish to interface with their electronics silently, without the need for any audible speech.

The larynx member 14 is capable of providing audio from the microphones and raw data from the on-board sensors, but it can also pre-process these waveforms and yield processed ultrasound imagery from the piezoelectric array representing muscular movement in the larynx and muscles in the surrounding area. Muscular data is also generated as the tongue moves in order to form speech, even when the user is speaking silently. The raw waveforms are processed using a machine learning algorithm that can be trained to recognize specific words, phrases, and sounds. Ultrasound imagery from the piezoelectric array is converted into a matrix of reflected distances to individual parts of the muscle, similar to pixels on a computer monitor. These waveforms and distance matrices are run through machine learning, in order to identify specific patterns that represent known words and phrases (even if they are of a non-language).

In one embodiment, the machine learning algorithm can be trained with a software training routine that asks the user to say phrases in their own language. As the device captures the waveform signatures for each word or phrase, the machine learning algorithm will produce numeric training vectors. As is common with machine learning, this process can occur in multiple iterations, and the training vectors improve over some period of time.

These vectors can be stored on an external device running the training software, or with the laryngeal interface, for use with other devices. These training vectors are used during normal operating to discern between known words based on waveform inputs. The device is not required to analyze the imagery from the ultrasound array visually, as the matrix of distances represents a depth bump map or topographical view of the larynx and throat muscles in action. Individual snapshots are taken on interval over time and can be triggered by the fact that the user is speaking via the accelerometer.

Raw waveforms or processed input can be returned to an external device, such as a wearable computer, that implements the same wireless protocol. For example, the larynx input device can be paired with an external computer over Bluetooth. The user would press a button on the device that causes it to enter pairing mode and then the device can be paired with another computer running the recognition software. As previously mentioned, the training vectors can be stored on the larynx device so that the recognition is consistent across multiple associated Bluetooth devices.

In one embodiment, the subvocalization sticker hardware of the larynx member 14 consists of a low-energy ultrasonic piezoelectric array or singular piezoelectric transducer. It rests on the outside of the neck and has a medical grade adhesive that holds the device securely in-place on the outside of the neck. It should be positioned so that it is facing the larynx, near to the laryngeal nerve bundle, underneath the jaw, on the spot on the outside of where trained physicians and athletes are instructed to check their pulse rate. This area is ideal, because there is a good view of the muscle tissue, data about the user's pulse rate is available, and the user can still turn their head side-to-side without significantly flexing the device out of place.

Typical frequency ranges for these transducers fall outside of human hearing ranges, above 20 Khz, and more specifically between 1 Mhz and 10 Mhz for this application. Transducers used in medical imaging range into higher frequencies depending on the desired depth and type of tissue. In this case, the tissue depth of penetration is minimal, as the diameter of the neck is limited. The device penetrate past the epidermal layer to measure the depth to the first layer of the platysma muscle, which wraps around the entire front and sides of the neck, connects directly to the underside of the skin, and plays an important role in facial expression. The device is meant to reach deeper and may be able to reach multiple muscle groups in the area, including the muscles of the larynx, which are directly responsible for movement within the voice box.

This component emits inaudible tones at specific frequencies for the purpose of deep tissue imaging. The transducer is triggered as the device detects that the user is speaking. In this case, the user may be speaking normally or subvocalizing to the device, which causes multiple muscles in the sides of the neck to contract. The on-board accelerometer can be used to indicate that there is movement, especially when the mouth is open, and the user U is engaged in self-talk.

Even though the sticker is a small slim device that rests on the outside of the neck, it is still it still has an embedded processor, memory, and a wireless chipset. The proposed design has pull-tab functionality, with a medical-grade adhesive material used to affix it to the neck. For situations where the sticker does not make full contact or is not flush with the binding site, the user can apply a tiny amount of an ultrasound gel directly on between the skin and the piezoelectric sensing array. Any excess ultrasound gel will escape through an inset escape channel, which ensures that there are no air pockets between the piezoelectric array and the surface of the skin.

The applications of the wearable device 10 and the larynx member 12 are numerous. By way of example and not by way of limitation, laryngeal and mental illness, hybrid gestures, instant purchases, telephony, and casual navigation will be presented with a few other examples.

With respect to laryngeal and mental illness, which are disorders of the larynx such as irritable larynx disorder, and psychiatric conditions like anxiety, post-traumatic stress disorder, and schizophrenia, this may cause unintended muscular movements resulting in partial subvocalization. The larynx device can help users recognize when they have lost focus or have begun unintentional self-talk that might be making their condition worse. If the person has an irritable larynx, or physical damage to the surrounding tissue, a doctor may have instructed them to avoid speaking in order to let the affected area heal. In the case of anxiety disorders, users may be out of sync with reality, subvocalizing about their worries unintentionally. By bringing unintentional laryngeal movements to the user's attention, the device can help users train themselves to focus on their surroundings.

With respect to hybrid gestures, since the wearable device 12 doesn't have a screen, it draws on its ability to determine the cardinal directions of nearby devices. Although these directions do necessarily need to relate to true cardinal directions like North, South, East, and West, the wearable device 12 understands the bearings of nearby external devices in relation to itself. For example, the user might decide that they want to share a piece of content, and instead of choosing a destination device on a menu screen, users would perform a swipe gesture in the direction of the destination device. The user might also point the device itself in the direction of the destination device, and perform a gesture that would take some action, such as a file copy or initiating the pairing process.

On that note, users might decide to perform a gesture at a nearby wireless access point for the purpose of key-pairing with that access point. This process might involve a protocol similar to WPS (Wireless Protected Setup) for backward compatibility, or another wireless protocol. Additionally, users might share individual wireless keys by performing gestures at one another, which is analogous to simply writing a WiFi key down of a piece of paper and handing it to the other person.

With respect to instant purchases, users can query the prices of items at retail outlets or commercial goods or perform silent transactions. One potential usage of the system is to enable instant purchasing in stores. As the shopper looks through items on the store shelves, consider buying an item by silently vocalizing a phrase like, “I want to buy these [item name].” The system will detect that pattern of text and select the named item in front of them. In order to complete the purchase, the user would perform a brief gesture, such as holding the wearable device 12 for a few seconds, which begins a cancelation timer. If the user should later decide that he did not actually intend to buy the item, the user can say an abort phrase such as, “I didn't want to buy that”, which will revert the item to its unpurchased state. Other similar use cases might involve using the wearable device 12 to order food from your favorite restaurants, scheduling pickup or delivery. EUNA would be there to assist the user with purchasing and pricing and can help confirm the order. It can also help users perform financial transactions between one another.

With respect to telephony, another use case involves instant messaging (SMS, Email, and IM), and other similar methods of communication. Users should be able to conduct silent phone calls or interface with EUNA (i.e., an AI assistant inside the wearable device, and device AI.) silently to draft messages grammatically correct and/or spell check, send messages, and offer advice pertaining to the user's calendar, location, and nearby devices.

With respect to casual navigation, instead of inputting information into the device and receiving responses back, users can choose to silently communicate with the voice assistant for a more casual and human-like account of the systems state and commands. This means someone could silently use the wearable device to navigate the city in real-time. EUNA could become aware that the user has anxiety, tending to the situation, or respond to requests more casually when the user just wants to get from one meeting location to another:
“Josh, breathe, nothing to work about, do you see that red fire hydrant directly in front of you about 10 more steps/paces ahead of you? Walk directly past it and make a left at the next street comer. Then proceed towards the green umbrella at the end of the block.”
“You are about to make a left turn onto the opposite side of the street. The green umbrella is in front of the Starbucks.”
As the user approaches the Starbucks:
“Josh, do you see the green car? I believe a Prius is coming up on your left.”

Euna would be aware of the turn signal indicators as well as the objects and colors of the objects, mobile devices, IoT devices, vehicles, and the wearable device 12 user's clothing in proximity to you, and other pertinent data for a more human-to-human casual navigation experience, which can be loaded from an external data set. Users can opt-in to share information which would improve the system. For example, the user might share their shirt color.

EUNA becomes the user's personalized virtual assistant, with hopes that it can become a truly artificial domain agent the lives on each domain pocket. EUNA can move onto any of the devices for which the user verifiably has the keys. The agent might access resources on the user's behalf or help the user with what they are doing, with situational awareness about device's and their directionality from the requesting device. Besides the direction that neighbors are in, and the system and voice assistant might use data about the surroundings, including environmental features, man-made structures, buildings, stores, commercial environments, retail environments, recreational facilities, restaurants, offices, vehicles, and the colors of objects, in providing a frame of reference for the user in physical terms. Another example would be helping guide someone through a crowd of people, by referencing the nearby objects and outfits in order to guide the user to the intended person. Consider also, that the owners of a transportation network decide to install named wireless devices that can help users navigate through a sea of devices, as an electron would flow across a metal in the sea of electrons.

With respect to a distributed search, users can silently query the wearable device 12 for information from a search engine, storing data in a cryptographically secure fashion that is tied to a unique device identifier. The dynamic real-time location of the wearable device 12 that made the query is stored in a distributed data center, allowing the device to simply query the information from the distributed data center, instead of repeatedly querying the same searches over and over. Euna can also be configured to share pertinent data between devices in close proximity to one another when the wearable devices 12 come within range. Likewise, a user might be navigated to and pick up a file that the AI remembers was on another computer. The user might need to make a physical connection, or otherwise download the file over an available wireless radio. It this case, when the device is in range of or navigating to the pickup location. (within range)

With respect to socialization and dating, an example would be, the user silently subvocalizes that the individual in front of him or her is attractive and wishes they would talk to him. EUNA can actively inspire individuals to talk to one another when both parties have opted-in and have chosen to share their profile information, and are looking to meet people in the area:
“The woman in front of you with the colorful backpack is attractive. She is a cyber security engineer at Amazon, and works one block away from you. You should go speak to her, ask her about [user interest].”

Users can query, and/or have an automatic feature of the wearable device 12 that listens to your subvocalizations and detects users who think someone is attractive, and listen if X individual also has the wearable device 12 on that thinks that they are attractive, then an automatic date request goes out to both parties alerting them to the mutual interest.

With respect to accessibility, the goal is to create a system which aids users in interacting with the world around them, recognizing danger, and remaining connected in an interconnected world. This technology can help users automatically find their friends and peers. For example, there might be a hospital nurse who needs find a specific doctor for the patient, but the doctor isn't in the radiology department where the nurse remembered. The doctor may choose to broadcast their location, when acting as a staff member, so that patients and other staff can find them quickly. It can also detect nearby obstacles with the radar chipsets, and alert users that they are about to make a mistake in their object to object navigating. Users who wish to call for help can place emergency calls, but there should also be an audible/non-audible feedback mechanism on-board to let the user know that help is on the way.

With respect to security and authentication, users should be able to use gestures in combination with the laryngeal interface in order to unlock electronic doors, garages, and gates. The system is also useful for cryptographically secure authentication between IoT devices, and can be used as an authentication badge computer with secondary-factor authentication (2FA) support built into it. As an example of this, the owner of the wearable device 12 might draw their unlock code on the touch surface, or look at a door, and subvocalize an opening phrase like, “let me in”, or a closing phrase like, “lock the door”. The phrases are configurable, but there should be sane defaults in place so that there are common opening and closing phrases for public doors and objects.

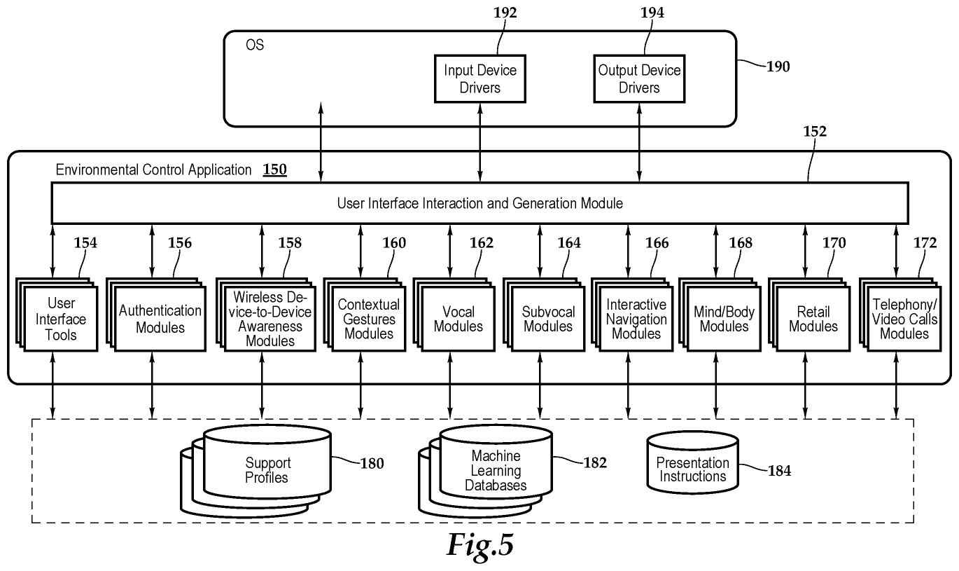

FIG. 5 conceptually illustrates the software architecture of an environmental control application 150 of some embodiments that may utilize the wearable device 12 and the larynx member 14. In some embodiments, the environmental control application 150 is a stand-alone application or is integrated into another application, while in other embodiments the application might be implemented within an operating system 190. Furthermore, in some embodiments, the environmental application 150 is provided as part of a server-based solution or a cloud-based solution. In some such embodiments, the application 150 is provided via a thin client. That is, the application 150 runs on a server while a user U interacts with the application 150 via a separate machine remote from the server. In other such embodiments, the application 150 is provided via a thick client. That is, the application 150 is distributed from the server to the client machine and runs on the client machine. In other embodiments, the application 150 is partially run on each of the wearable device 12 and the larynx member 14.

The environmental control application 150 includes a user interface (UI) interaction and generation module 152, user interface tools 154, authentication modules 156, wireless device-to-device awareness modules 158, contextual gestures modules 160, vocal modules 162, subvocal modules 164, interactive navigation modules 166, mind/body modules 168, retail modules 170, and telephony/video calls modules 172. In some embodiments, storages 180, 182 184 are all stored in one physical storage. In other embodiments, the storages 180, 18, 284 are in separate physical storages, or one of the storages is in one physical storage while the other is in a different physical storage.

The UI interaction and generation module 152 generates a user interface that allows the end user to utilize the wearable device 12 and the larynx member 14.

During use, various modules may be called to execute the functions described herein. In the illustrated embodiment, FIG. 5 also includes an operating system 190 that includes input device drivers 192 and output device drivers 194. In some embodiments, as illustrated, the input device drivers 192 and the output device drivers 194 are part of the operating system 190 even when the environmental control application 150 is an application separate from the operating system 190.

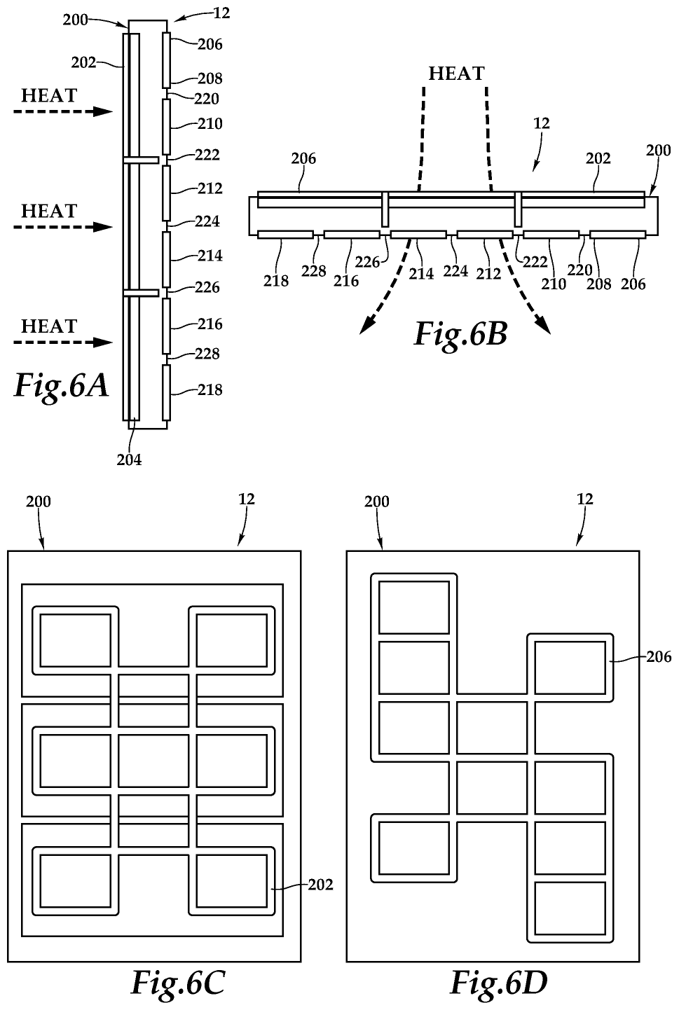

In one embodiment, the wearable device 12 may be a device that is capable of being wirelessly charged using a handshake-based power supplicant protocol. For charging in general, the wearable device 12 uses an electronic fuse, that is, a circuit that is disconnected magnetically when there is enough power to cause it to disengage, which is common among laptops and smartphones. By way of example, the wearable device 12 may be charged in the user's pocket using body heat to generate energy from the transference of heat across the wearable device 12. A Seebeck effect may be utilized. As shown in FIG. 6A, FIG. 6B, FIG. 6C, and FIG. 6D, a Seebeck configuration 200 includes heat absorption panels over a thermoelectric generator array 204. Internal electronics and the device battery charging circuit 205 are located within the wearable device 12. A heat dissipation assembly 206 includes insulated heat dissipation array panels 208, 210, 212, 214, 216, 218 with heat pipe channels 220, 222, 224, 226, 228 interposed therebetween.

More specifically, the thermal charging capability is derived from the science of thermocouple technology, as uses the Seebeck Effect is leveraged to generate electricity from the transference of heat from one side of the device to the other. This means that one side of the charging plate will ‘absorb’ heat from the user's pocket, and the movement of thermal energy is converted into electricity. It also means that the other side of the plate, that faces the device itself, will be colder, which has a certain degree of usefulness in terms of cooling the device. To facilitate this, copper cooling arrays inside the device diffuse heat away from the inside of the plate.

In other cases, the Seebeck effect is used in a bi-directional fashion to diffuse heat in both directions. Thermoelectric coolers might be used to regain some of the electricity that the device has diffused into heat, cycling heat back across the absorption side of the thermoelectric surface to create the highest temperature differential between either side of the module. This secondary technique, especially in combination with the first technique, will extend battery life, and allow the user to charge their device with heat from their pocket, a car dashboard, hot-plate, next to a camp-fire, and other sources. It also has promise for allowing people without electricity or on the go to charge their devices and participate in the global Internet community. Users who can make fire can charge their devices by heating them on one side. That being said many of the implementations of thermoelectric coolers have a maximum heat capacity per square cm of embedded plates. As such, the design on the area should show both a symbol for thermal and inductive charging with the maximum temperature listed, and the device should have a temperature sensor near the area to alert the user before the danger threshold is met for the high-temperature surface.

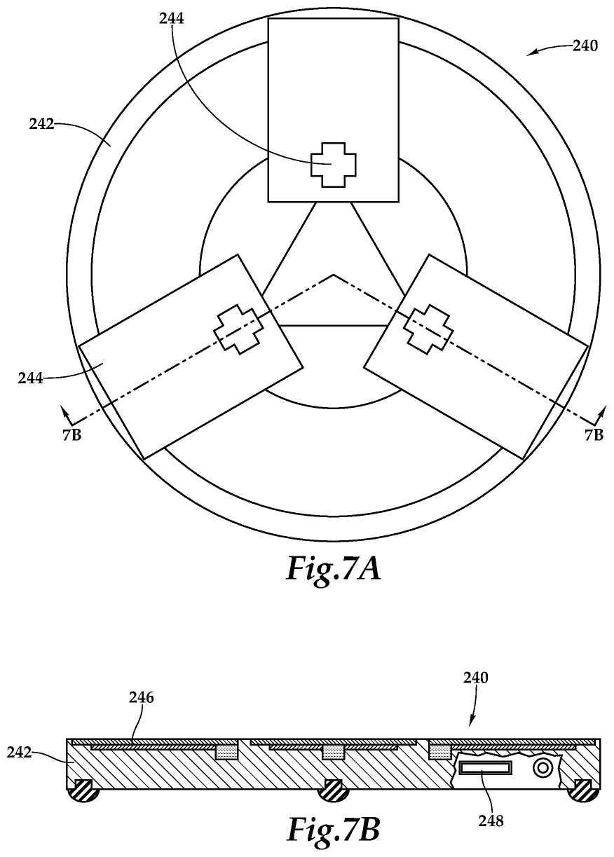

With reference to FIG. 7A and FIG. 7B, in another implementation, a thermoelectric wireless charging pad 240 may be utilized to provide power. The pad 240 might start supplying a continual current to the wearable device 12, however, the handshake/negotiation process is designed to allow devices to signal to the pad 240 how much current how much heat to output, and likewise, the pad 240 might signal the amount of current it can output. Charging pads that support multiple devices might have less current available for the device, splitting the current in half each time a new device is added. As such the pad 240 might state that it can support specific modes (80 mW, 128 mW, 256 mW, as so forth) that are allowable, and the device might have overlapping supported modes, that both parties must agree upon before the actual charge event. The parties may also agree upon a temperature, with the understanding that future thermoelectric models will have higher temperature tolerances and higher efficiencies. Ideally the thermoelectric modules would withstand direct flame temperatures and have 100% efficiency. The hardware that is built today should have both smart and dumb charging capabilities and support for future thermoelectric hardware. This helps to protect the wearable device 12 from unsupported modes that might cause damage to the internal electronics, and allows the pad 240 to negotiate power to multiple wearable devices 12, while maintaining that charge times are uniform between devices. As depicted, in one embodiment, the pad 240 includes a graphite thermal body 242 having placement points 244, footpads 246, a heating coil 246 as well as a USB connection 248.

The order of execution or performance of the methods and data flows illustrated and described herein is not essential, unless otherwise specified. That is, elements of the methods and data flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A wearable device for a user, the wearable device comprising:
a hardware layer having a processor, a memory, and a transceiver, the processor, the memory, and the transceiver being interconnected by a busing architecture, the transceiver receiving laryngeal data relative to the user;
a touch layer located in communication with the hardware layer, the touch layer having a capacitive touch surface that receives contact data;
a radio layer located in communication with the hardware layer, the radio layer having an antenna array, the radio layer including a plurality of antennas that receive radio data, the radio data being used to identify points of origin of incoming radio signals; and
the memory accessible to the processor, the memory including processor-executable instructions that, when executed, cause the processor to:
process the radio data and the contact data to at least one of increase internet-of-things awareness and execute a gesture command originating from the user, and
process the laryngeal data to execute a vocalization command originating from the user.

2. The wearable device as recited in claim 1, further comprising a form factor of a badge, the badge being releasably securable to clothing of the user.

3. The wearable device as recited in claim 1, further comprising an electrical layer in communication with the hardware layer, the electrical layer comprising a power source and a heatsink.

4. The wearable device as recited in claim 1, wherein the internet-of-things awareness further comprises authentication relative to credentials.

5. The wearable device as recited in claim 1, wherein the internet-of-things awareness further comprises wireless device-to-device awareness.

6. The wearable device as recited in claim 1, wherein the internet-of-things awareness further comprises retail activity.

7. The wearable device as recited in claim 1, wherein the internet-of-things awareness further comprises a telephony application.

8. The wearable device as recited in claim 1, wherein the internet-of-things awareness further comprises interactive navigation.

9. The wearable device as recited in claim 1, wherein the gesture command further comprises hand and arm movements of the user.

10. The wearable device as recited in claim 1, wherein the vocalization command further comprises transmission of an audible vocalization.

11. The wearable device as recited in claim 1, wherein the vocalization command further comprises transmission of a sub-audible vocalization.

12. The wearable device as recited in claim 1, wherein the vocalization command further comprises execution of an audible command.

13. The wearable device as recited in claim 1, wherein the vocalization command further comprises execution of a sub-audible command.

14. The wearable device as recited in claim 1, wherein the memory accessible to the processor cause the processor to process the laryngeal data relative to a psycho-emotional state originating from the user.

15. A wearable device for a user, the wearable device comprising:
a hardware layer having a processor, a memory, and a transceiver, the processor, the memory, and the transceiver being interconnected by a busing architecture, the transceiver receiving laryngeal data relative to the user from a larynx member;
a touch layer located in communication with the hardware layer, the touch layer having a capacitive touch surface that receives contact data;
a radio layer located in communication with the hardware layer, the radio layer having an antenna array, the radio layer including a plurality of antennas that receive radio data, the radio data including an identification of the points of origin of incoming radio signals;
the memory accessible to the processor, the memory including processor-executable instructions that, when executed, cause the processor to:
process the radio data and the contact data to at least one of increase internet-of-things awareness and execute a gesture command originating from the user, and
process the laryngeal data to execute a vocalization command originating from the user; and
the larynx member including an ultrasonic piezoelectric member to measure laryngeal data.

16. The wearable device as recited in claim 15, further comprising a form factor of a badge, the badge being releasably securable to clothing of the user.

17. The wearable device as recited in claim 15, further comprising an electrical layer in communication with the hardware layer, the electrical layer comprising a power source and a heatsink.

18. A wearable device for a user, the wearable device comprising:
a hardware layer having a processor, a memory, and a transceiver, the processor, the memory, and the transceiver being interconnected by a busing architecture, the transceiver receiving laryngeal data relative to the user;
a touch layer located in communication with the hardware layer, the touch layer having a capacitive touch surface that receives contact data;
a radio layer located in communication with the hardware layer, the radio layer having an antenna array, the radio layer including a plurality of antennas that receive radio data, the radio data including an identification of the points of origin of incoming radio signals; and
the memory accessible to the processor, the memory including processor-executable instructions that, when executed, cause the processor to:
process the laryngeal data to execute a vocalization command originating from the user.

19. The wearable device as recited in claim 18, further comprising a form factor of a badge, the badge being releasably securable to clothing of the user.

20. The wearable device as recited in claim 18, further comprising an electrical layer in communication with the hardware layer, the electrical layer comprising a power source and a heatsink.
